(19) United States
(12) Patent Application Publication
(10) Pub. No.: US 2013/0238974 A1
(43) Pub. Date: Sep. 12, 2013

(54) ONLINE POLLING METHODOLOGIES AND PLATFORMS

(71) Applicants: Daniel Alexander Beltramo, JR., San Francisco, CA (US); Nicholas Naveen Rau, San Francisco, CA (US); Leon Mack Tilling, Mill Valley, CA (US)

(72) Inventors: Daniel Alexander Beltramo, JR., San Francisco, CA (US); Nicholas Naveen Rau, San Francisco, CA (US); Leon Mack Tilling, Mill Valley, CA (US)

(21) Appl. No.: 13/604,195

(22) Filed: Sep. 5, 2012

Related U.S. Application Data
(63) Continuation of application No. 12/251,931, filed on Oct. 15, 2008.
(60) Provisional application No. 60/980,373, filed on Oct. 16, 2007.

(51) Int. Cl. G06F 17/22

(52) U.S. Cl. CPC G06F 17/2247
USPC 715/234

(57) ABSTRACT

Systems, methods, and articles of manufacture for polling users are disclosed. An example method is disclosed that involves counting a number of times a first poll is provided for display to a user with two or more different webpages in two or more different Internet domains and, if the number of times the first poll has been provided for display to the user exceeds a first threshold number of times, selecting a second poll for display to the user with the two or more different webpages or a third webpage different from the two or more different webpages.

### CROSS-REFERENCE TO RELATED APPLICATIONS

This patent arises from a continuation of U.S. patent application Ser. No. 12/251,931, which was filed on Oct. 15, 2008, and which claims the benefit of U.S. Provisional Application Ser. No. 60/980,373, which was filed on Oct. 16, 2007, both of which are hereby incorporated by reference in their entireties.

### FIELD OF THE DISCLOSURE

This disclosure relates generally to systems for online polling of users.

### BACKGROUND

It is often desirable to gather the opinions or characteristics of a population. One way this can be done by polling a group of people. The people can be asked about their opinion on certain matters or can be asked for demographic information about themselves (e.g., age, gender, marital status). These polls are useful for a variety of purposes. For example, a business can use polls to perform market research, including getting opinions about possible product ideas and getting information about their potential customers. Research through polls may also be conducted by other parties, such as academic researchers or the government.

In many cases, the research requires that the polling be targeted to a specific group of people with certain characteristics. For example, a business may want to target its polling to people who have characteristics that would make them likely customers. To do this, the business may need to recruit people with specific backgrounds or perform panel-based research. This can be expensive and require a significant amount of time. Panels are also often subject to incentive biases and self-selection biases. Therefore, there is a need in the art for a way to poll a desired group of people, where a potentially large group of people can be reached quickly and inexpensively.

### BRIEF DESCRIPTION OF THE DRAWINGS

FIG. 1 is a high-level diagram illustrating an example environment for polling users.

FIG. 2 is a block diagram illustrating an example computer that can serve as a polling server, researcher client, publisher server, or poll user client.

FIG. 3 is a block diagram illustrating an example polling server.

FIG. 4 is a flowchart illustrating an example method for polling users.

FIG. 5 is a flowchart illustrating an example method for characterizing and polling users.

The figures depict example implementations constructed in accordance with the teachings of this disclosure for purposes of illustration only. One skilled in the art will readily recognize from the following description that alternative examples of the structures and methods illustrated herein may be employed without departing from the principles of the teachings disclosed herein.

### DETAILED DESCRIPTION

The above need is met by a system, method, and computer program product for polling users. In an example of the method, targeting parameters for a plurality of poll campaigns are received. The targeting parameters indicate the desired characteristics of a user audience for a poll campaign. Information about the type of content on a publisher webpage or the characteristics of typical visitors to the webpage is also received. A user is characterized based on the user's responses to characterization polls, such as polls that ask for demographic information about the user. A request for displaying a poll in a poll zone of the publisher webpage is received, and a poll is selected for display based at least in part on the targeting parameters, information about the publisher webpage, and the characterization of the user. In another example of the method, the audience of the publisher webpage is characterized based on responses to characterization polls by visitors to the publisher webpage.

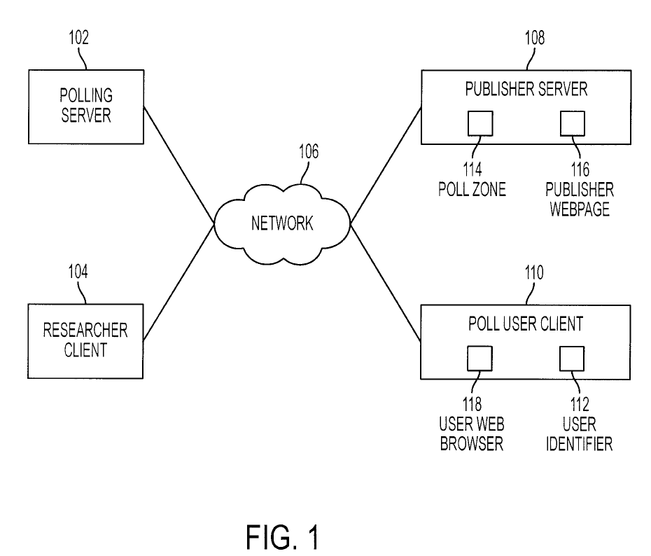

FIG. 1 is a high-level diagram illustrating an example environment 100 for polling users. The environment 100 includes a polling server 102, a researcher client 104, a publisher server 108, and a poll user client 110. The polling server 102 receives requests to display various polls and causes the polls to be displayed. A researcher can submit a request to display a poll using a researcher client 104. The polling server 102 can then present the poll on an appropriate publisher webpage 116 of the publisher server 108, and the poll can be viewed and responded to by users from user web browsers 118 on poll user clients 110. Though only one researcher client 104, publisher server 108, and poll user client 110 are shown in FIG. 1, there may be thousands of these entities in the environment 100. There may also be multiple polling servers 102 for load balancing or backup purposes. The polling server 102, researcher clients 104, publisher servers 108, and poll user clients 110 can communicate through a network 106, such as the Internet.

A research client 104 can be used by a researcher to interact with the polling server 102. A researcher can create a poll campaign comprising poll information and targeting parameters. The poll information includes one or more poll questions that are interactively displayed to and answered by a group of users. The targeting parameters specify desired characteristics of the group of users to which the poll is displayed and the desired characteristics of the publisher webpages 116 on which the poll is displayed. A researcher can be, for example, a corporation or an academic researcher. After the poll has been answered by some users, the researcher receives the results and can use the results for market research or other purposes. The researcher may pay a fee to the polling server operator for running a poll campaign. The researcher can use the researcher client 104 to submit poll campaigns, receive results, and submit payment to the polling server 102.

In some examples, the publisher server 108 displays polls to users. The publisher server 108 can be operated by a publisher that provides content or services to users. A publisher can be, for example, an operator of a news website, a web log (blog), a search engine, or any other website that users are likely to visit. The publisher server 108 may include a web server that displays various publisher webpages 116 to users. Some of these web pages may include poll zones 114 for displaying polls provided by the polling server 102. In some examples, a poll zone 114 is a widget included on a publisher webpage 116 for displaying polls in a specified format and location on the webpage. Users can view polls on the publisher webpage 116 and submit answers to the polls. The poll results can then be sent back to the polling server 102 for retrieval and analysis by researchers and the publisher.

A publisher webpage 116 may attract viewers with specific characteristics. For example, a webpage 116 offering discounts for seniors may attract older users, while a blog about patent law may attract users who are patent lawyers. The audience characteristics of a publisher webpage 116 may be used to determine the polls that the polling server 102 provides to the publisher 108. This determination can be made based targeting parameters provided by the researcher. The publisher can be paid by the polling server for displaying polls to users. The publisher server 108 may also display unpaid polls for its own purposes, such as learning about its viewer demographics or providing entertainment to its viewers.

A user interacts with a publisher server 108 through a poll user client 110. The poll user client 110 can execute a user web browser 118 for displaying publisher webpages 116 containing polls. The user generally visits the publisher webpage 116 for the purpose of accessing content or services, but may notice a poll displayed in a poll zone 114 and decide to participate in the poll. A user identifier 112 may be stored on the poll user client 110 to identify a particular user across multiple browsing sessions and multiple publisher servers 108. In some cases it is not possible to differentiate between individual users on a poll user client 110, so in this case, a “user” represents all users from a particular poll user client. This user identifier 112 may be used by the polling server to track the polls previously viewed by and answered by the user so that appropriate polls can be displayed to the user in the future. The user identifier 112 may also be used to correlate the user's answers to one poll with the user's answers to another poll for analysis purposes. The user identifier 112 can be implemented as a web cookie managed by the user web browser 118.

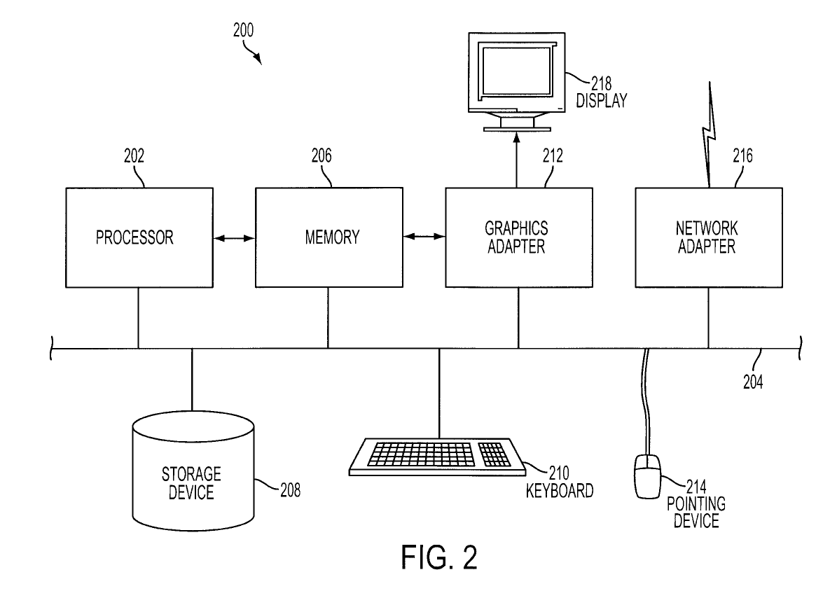

FIG. 2 is a block diagram illustrating an example computer 200 that can serve a polling server 102, researcher client 104, publisher server 108, or poll user client 110. Illustrated are at least one processor 202 coupled to a bus 204. Also coupled to the bus are a memory 206, a storage device 208, a keyboard 210, a graphics adapter 212, a pointing device 214, and a network adapter 216. A display 218 is coupled to the graphics adapter 212. The storage device 208 is a device such as a hard drive, CD or DVD drive, or flash memory device, and holds files containing executable code and/or data utilized during the operation of the computer 200. The memory 206, in some examples, is a random access memory (RAM) and holds instructions and data loaded from the storage device 208, generated during processing, and/or from other sources.

Computers acting in different roles may have different and/or additional elements than the ones shown in FIG. 2. For example, a computer 200 acting as a polling server 102 may have greater processing power and a larger storage device than a computer acting as a poll user client 110. Likewise, a computer 200 acting as a polling server 102 may lack devices such as a display 218 and/or keyboard 210 that are not necessarily required to operate it.

The computer 200 executes one or more operating systems such as a variant of MICROSOFT WINDOWS or LINUX. In general, the operating system executes one or more application programs. The operating system and application programs executed by the computer are formed of one or more processes. This description utilizes the term “module” to refer to computer program logic for providing a specified functionality. A module can be implemented in hardware, firmware, and/or software. A module is typically stored on the storage device 208, loaded into the memory 206, and executed by the processor 202. A module can include one or more processes, and/or be provided by only part of a process.

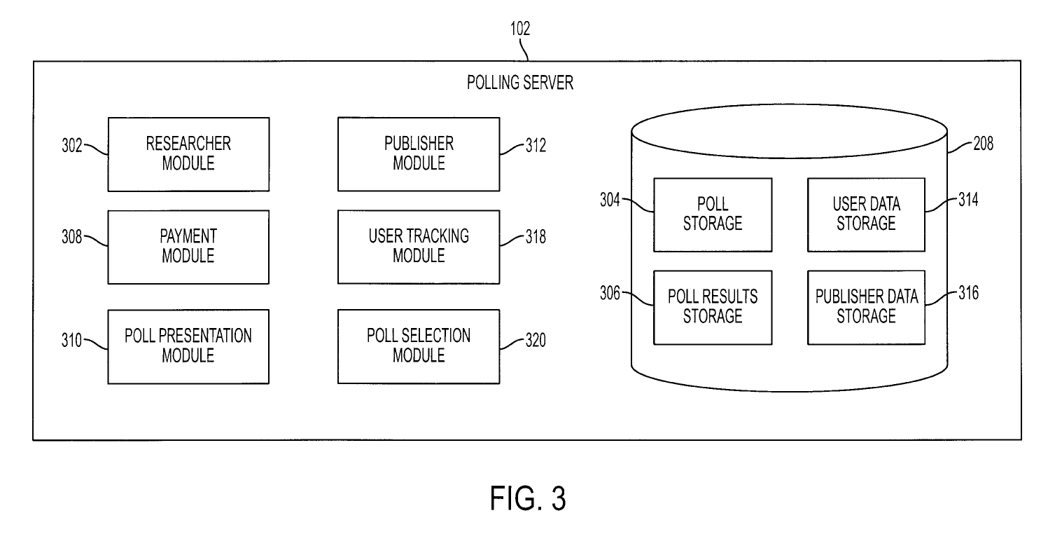

FIG. 3 is a block diagram illustrating an example polling server 102. As mentioned above, the polling server 102 interacts with researcher clients 104 and publisher servers 108. The researcher module 302 can be used to interact with a researcher client 104. The researcher module 302 may include a web server that serves web pages to a browser running on the researcher client 104, providing a researcher with a graphical user interface to the polling server 102. The researcher module 302 receives poll campaign information from a researcher, the poll campaign information including poll question information and targeting parameters.

The researcher module 302 can assist the researcher in creating poll question information by presenting various options for designing a poll to the researcher. Poll question information may include a text prompt, such as “What is your marital status?” or “Choose your favorite actor from the choices below” followed by possible response choices. The poll question information may indicate that only one response choice can be selected by a user, or may allow for selection of multiple response choices. The poll question information may specify that the answer choices should be displayed in the same order each time, or may specify that the answer choices be displayed in a random order (e.g., to reduce bias). The poll question information can include graphic images to be displayed along with the text prompt or any of the response choices. The poll question does not need to be in a multiple-choice format. The poll question information can specify that users respond to the text prompt by typing in a text response.

The researcher module 302 can also assist the researcher in creating targeting parameters. These parameters can specify that a poll question be displayed a certain number of times, for a certain length of time, or until a certain number of responses are received. The targeting parameters can also include information that specifies a desired audience for the polls. This can include demographic criteria for poll users, such as age, gender, income, marital status, and geographic location. The parameters can specify that the poll should only be shown to users that are known to meet the desired demographic criteria.

The parameters can also indicate criteria for determining the publisher servers 108, webpages 116, and poll zones 114 on which to display the poll question. The parameters can specify that the poll question should be displayed on publisher servers 108 that are known to have an audience from a particular country or with a generally known demographic. The parameters can also indicate that the publisher server 108 have a specific type of audience such as tech-savvy users, physicians, or politically conservative college students. The parameters can specify that the poll question should be displayed on webpages 116 with certain types of content such as tech news, entertainment news, or stock quotes. The parameters can also list specific publisher servers 108 or webpages 116 for displaying the poll question.

The researcher module 302 can store the poll campaign information received from the researcher in the poll storage 304. The poll storage 304 stores poll campaign information for research polls and for other types of polls, described below. The poll storage 304 can be accessed by other modules to present the polls to users. Once a research poll campaign has been defined, the polling server 102 can quickly begin displaying the poll question to users. This allows for results to be obtained faster than traditional methods where a panel of users must first be assembled before polling begins. The researcher module 302 can also be used to provide poll responses to the researcher. Poll responses can be accessed from the poll results storage 306, described below. Poll responses can be provided while the poll is still running and can be updated in real time. An analysis of the responses can also be provided, such as a breakdown of responses by various demographic categories of users, or by the publisher webpages 116 or poll zones 114 used to display the poll.

The publisher module 312 can be used to interact with a publisher. The publisher can interact with the publisher module 312 through the publisher server 108 or through another computer 200 (not illustrated). The publisher module 312 may include a web server that serves web pages to a browser used by a publisher, providing the publisher with a graphical user interface for communicating with the polling server 102.

A publisher can configure poll zones 114 on its web pages 116 for displaying polls provided by the polling server 102. The types of polls that can be displayed include research polls, demographic polls, publisher polls, and content polls. Research polls are polls designed by a researcher, as described above. The publisher may be compensated for displaying research polls. Since a given research poll campaign can be spread across multiple publisher servers 108, the poll can be used effectively even on small publisher servers 108 with relatively few visitors.

Demographic polls request demographic information about users. For example, a demographic poll question may ask “How old are you?” and provide various age ranges as possible answers. Demographic polls allow the polling server 102 to learn demographic information about poll users. This information can be used to determine whether a user satisfies the targeting parameters of a research poll so that the research poll can be displayed to the user. Research poll results can also be analyzed by correlating the results with demographic information of users. Demographic information can also be provided to a publisher to help the publisher learn about the visitors to its webpages 116 (i.e., characterize the audience of its webpages). Since a publisher receives valuable information from demographic polls, the publisher may not be compensated for displaying these polls. The results of demographic polls may also be provided or sold to external parties that are interested in knowing about visitors to the publisher's webpages 116. A predetermined set of standard demographic questions can be used by the polling server 102 for demographic polls.

A publisher poll is a poll that is designed by a publisher for display on the publisher's webpages 116. A publisher poll can be used by a publisher to get the opinions of visitors to its website. A publisher poll is similar to a research poll, but is limited to display on the publisher's own webpages 116. The publisher module 312 can include features similar to the features in the researcher module for assisting the publisher in creating poll question information and, if desired, targeting parameters for targeting the poll to specific users. The results of the publisher poll can be provided to the publisher along with a demographic breakdown of the results.

Content polls are predetermined poll questions designed to serve as additional content for a publisher's webpages 116. Content poll questions may include entertaining questions about political candidates or television shows, for example. A publisher may choose to display a content poll on its webpages 116. Since predetermined questions are available, a publisher does not expend effort designing poll questions. The results of content polls can be provided to the publisher through the publisher module 312. The publisher may use content polls to obtain additional psychographic data about its visitors to further characterize them.

The publisher module 312 enables a publisher to create poll zones 114 for displaying polls in the publisher's webpages 116. A poll zone 114 identifies a region of a webpage 116 where polls are displayed and includes configuration parameters for displaying the polls in the region. In one example, a poll zone 114 includes a widget on a publisher webpage 116, where the widget can display polls received from the polling server 102. This widget can be partially implemented as a code fragment included in the source code of the publisher webpage 116. The code fragment can be, for example, HyperText Markup Language (HTML) or JavaScript.

The publisher module 312 allows a publisher to choose various configuration parameters when creating a poll zone 114. The publisher can specify the height and width (e.g., in pixels) of the poll zone 114. The publisher can also specify the colors or color scheme to use for displaying the poll and can specify various other parameters controlling the display of the poll. The publisher can specify the types of polls (e.g., research polls, demographic polls, publisher polls, and content polls) that are allowed to be displayed in the poll zone 114. The publisher may also indicate the relative frequencies for showing the various types of polls. The publisher can specify further details about which polls should be displayed, such as identifying particular publisher polls or demographic polls, or indicating specific types of research polls to allow or disallow.

After receiving configuration parameters for a new poll zone, the publisher module 312 generates an identifier for the poll zone and stores the configuration parameters with the poll zone identifier in the publisher data storage 316. The publisher data storage 316 contains poll zone data and other data about publishers, described below. The publisher module 312 can also generate a widget to be included on the publisher webpages 116 to activate the poll zone and cause polls to be retrieved from the polling server 102 and displayed at the location of the widget. The widget may include the poll zone identifier so that the polling server is able to identify the poll zone.

The configuration parameters of a poll zone 114 can be changed after the poll zone has been created and deployed on publisher webpages 116. The publisher module 312 can allow a publisher to access the configuration of a poll zone 114 by inputting a poll zone identifier. The publisher module 312 can then allow the configuration parameters to be changed and saved to the publisher data storage 316. If a publisher notices a current poll campaign running in the publisher's poll zone 114 and desires to change it, the publisher can modify the configuration parameters of the poll zone to explicitly disallow the unwanted poll campaign.

When a publisher registers with the polling server 102 to create poll zones 114, the publisher module 312 can also obtain publisher information. The publisher information can be stored and later used to determine whether a publisher webpage 116 satisfies the targeting parameters of a research poll being considered for display on the webpage. To obtain this information, the publisher module 312 can ask the publisher about the type of content on its website and about the typical visitors to the website. The publisher module 312 can also request a uniform resource locator (URL) of the publisher website, retrieve the publisher webpages 116 from the website, and perform an automated analysis of the webpages (e.g., based on text and graphics) to determine the type of content. The publisher information can be stored in the publisher data storage 316 along with information about the publisher's poll zones 114.

The poll presentation module 310, user tracking module 318, and poll selection module 320 provide functionality for displaying polls in poll zones 114. When a user at a poll user client 110 views the publisher webpage 116 in a user web browser 118, the poll zone 114 of the publisher webpage directs the user web browser to the polling server 102 to retrieve poll content to display in the poll zone 114. The poll zone 114 may do this through code that causes the user web browser 118 to send a request to the polling server 102 for poll zone content, where the request includes the poll zone identifier (e.g., a number or character string).

In some examples, when a request for poll zone content is received by the polling server 102, the user tracking module 318 is notified. The user tracking module 318 keeps track of which poll zones 114 each user has viewed, across all poll zones of all publisher servers 108. Normally, if the user viewing the current poll zone 114 has previously viewed any poll zone, then the user web browser 118 will recognize the polling server 102 when sending the poll zone content request and will automatically also send the user identifier 112 associated with the user. The user tracking module 318 reads the user identifier 112 to determine the user and retrieves any stored information associated with the user from the user data storage 314. The user tracking module 318 provides the retrieved user information to the poll selection module 320.

The user data storage 314 contains information about users that have viewed polls. The user information can include previous polls that have been displayed to the user and previous poll answers received from the user. The user information can also include timestamps, publisher webpages 116, and poll zones 114 associated with the displayed and answered polls. The user information can be used for selecting a poll to display to the user, as described below. It can also be used to provide information about users to researchers or publishers.

In some cases, a user identifier 112 is not provided to the polling server 102 when a poll zone content request is received. This can occur because the user has never viewed a poll zone 114 before or because the user identifier was deleted since the last time the user viewed a poll zone. If no user identifier 112 is received, the user tracking module 318 can construct a new user identifier and provide the user identifier to the user web browser 118 to be stored on the poll user client 110. The user tracking module 318 can also create a new entry in the user data storage 314 associating the user identifier 112 with the new user.

The poll selection module 320 determines which poll to display in response to the current poll zone content request. The poll selection module 320 uses the poll zone identifier included in the request to retrieve the poll zone configuration parameters and publisher information from the publisher data storage 316. The poll selection module 320 also receives information about the requesting user from the user tracking module 318. Based on this information, the poll selection module 320 determines a poll to display. As mentioned above, information about active poll campaigns is stored in the poll storage 304. The poll campaigns include research polls, demographic polls, publisher polls, and content polls. Various algorithms that the poll selection module 320 might use are described below. If there are several possible polls that can be displayed, the poll selection module 320 can randomly select one of the possible polls to be displayed.

The poll selection module 320 can use the poll zone configuration parameter indicating the allowed poll types to select a poll for display or to narrow the possible polls that can be displayed. If the poll type parameter indicates that a research poll can be displayed, then the research poll campaigns can be searched to determine those that are appropriate for the poll zone 114. Research poll campaigns can be chosen based on a comparison of the poll's targeting parameters and publisher information retrieved from the publisher data storage 316. For example, if the publisher webpage 116 is a medical news website mostly viewed by physicians, research poll campaigns with targeting parameters specifying news content pages or a physician audience can be considered for display.

If the poll type parameter indicates that a publisher poll can be displayed, then poll campaigns created by the publisher can be considered for display. If the poll type parameter indicates that a demographic poll or content poll can be displayed, then the poll selection module 320 can choose a predefined demographic poll or content poll to be displayed. If the poll type parameter allows for multiple types of polls, various priorities can be assigned to poll types, such as giving paid research polls highest priority for display. Other poll zone configuration parameters can be examined to determine a poll to display. These parameters describe allowable poll subject matter, for example.

User information can also be used by the poll selection module 320. The poll selection module 320 can examine polls that the user previously answered or viewed to determine appropriate polls to show the user. This can avoid repeatedly presenting the same poll to the user. For example, if a user has already answered a certain demographic poll, a different demographic poll can be displayed so that more information about the user can be obtained. Also, if a poll has been shown to a user a certain maximum number of times, but the user has never answered it, a new poll can be shown to the user for a certain period of time (e.g., two weeks), before displaying the unanswered poll again. The maximum number can be higher for poll questions that are less likely to be answered (e.g., questions that take longer to read). If the user information indicates that the user has not yet answered an available research poll for which the user is qualified, that poll can be shown to the user rather than an available publisher poll or content poll.

Some polls may require that certain information about the user, such as demographic information, be known before the poll can be displayed. For example, a research poll campaign may have targeting parameters specifying that the research poll should only be displayed to users of a certain age range from a particular country. If the required information is not yet known for a particular user, then this research poll is not considered for display to the user. As a result, the poll selection module 320 may choose to display polls to the user that further characterize the user by obtaining further information about the user. These polls are referred to as characterization polls. Characterization polls are often demographic polls but can also include other types of polls such as publisher polls, content polls, or research polls. For example, content polls can provide psychographic data for characterizing users. The poll selection module 320 may choose to display several characterization polls in sequence to new users so that new users become rapidly qualified for a wide range of research polls that require knowledge of the user's characteristics.

The poll presentation module 310 manages the displaying of polls in poll zones 114 and the receipt of poll responses submitted by users. When the polling server 102 receives a request for poll zone content from a poll user client 110, the poll selection module 320 determines which poll should be sent (as described above) and the poll presentation module 310 composes a response that includes the selected poll. The poll presentation module 310 can retrieve poll question information about the selected poll, such as the text prompt and response choices, from the poll storage 304. If the poll question information indicates that the answer choices should be displayed in a random order, the poll presentation module 310 can choose a particular order for this instance of the poll. The poll presentation module 310 can also retrieve poll zone configuration parameters from the publisher data storage 316 to determine how to format the poll. These parameters may include the colors, fonts, and sizes to use for formatting the poll.

Based on the poll question information and poll zone configuration parameters, the poll presentation module 310 sends a response to a poll zone content request over the network 106. The response includes information that enables the selected poll to be displayed on the user web browser 118. The information in the response includes, for example, HTML code, JavaScript code, Adobe Flash code (e.g., ActionScript), graphics, text, animation, and sound. The information can also describe radio buttons for a user to select a poll response and a submit button for the user to submit the response. In one example, some general instructions for displaying polls may already be included in the poll zone 114. These general instructions can process the received information to display the selected poll.

The user web browser 118 receives the response and displays the selected poll to the user. When the user answers the poll (e.g., by selecting a response and pressing a “Submit” button), the user web browser 118 sends the answer chosen by the user to the polling server 102. The poll presentation module 310 receives this answer and stores the answer in the poll results storage 306. The poll results storage 306 stores the answer along with the identity of the user, the poll zone, a timestamp, and other desired information. The poll presentation module 310 also updates the user information in the user data storage 314 to reflect the user's answer to the poll, further characterizing the user. The poll presentation module 310 can send information to the user web browser 118 to be displayed in the poll zone 114 after the poll has been answered. This information can summarize the current poll results and possibly include a bar chart or pie chart.

In some examples, the payment module 308 processes payments between the researchers, publishers, and polling server operator. As mentioned above, a researcher can be required to pay a fee to have research polls displayed on publisher webpages 116. Also, a publisher can be paid for displaying research polls on its webpages 116. The payment module 308 can determine the amount due from a researcher and can determine the amount to be paid to the publisher, and can process the payments. The payment module 308 can use the researcher module 302 and publisher module 312 to send and receive payments. For example, an input form on a web page provided by the researcher module 302 can collect credit card information from a researcher

The amount to charge to a researcher can be based on the targeting parameters associated with the research poll campaign. A research poll that requires a greater number of responses or that runs for a longer time can incur a greater charge. Targeting parameters that specify a more narrow or unusual user demographic or that specify more restrictive publisher requirements can incur a greater charge. Publishers can be paid based on the number of times they display a research poll or the number of research polls that are answered by viewers of their websites. Publishers with viewer audiences that are more highly sought-after or that have more specific profiles can be paid a higher amount. The payment amounts can be set so that the amount paid by the researcher is somewhat greater than the amount paid to the publisher, allowing the polling server operator to receive payment for its services.

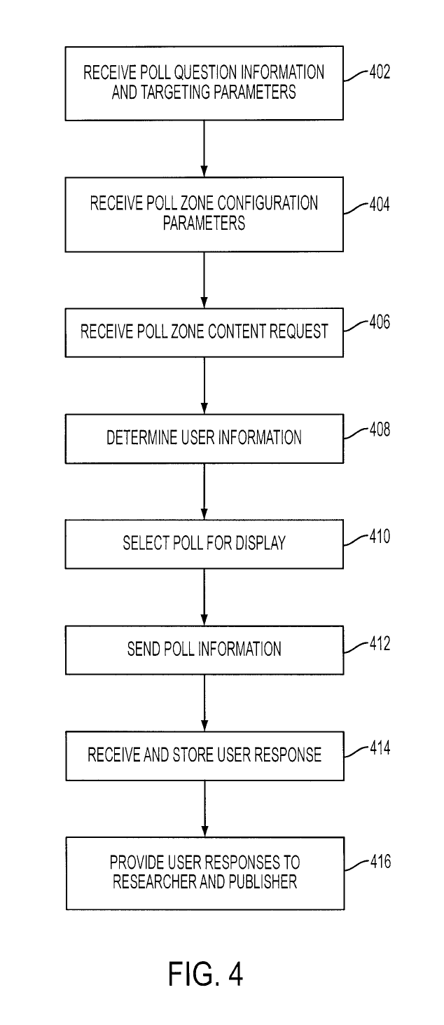

FIG. 4 is a flowchart illustrating an example method for polling users. The researcher module 302 receives 402 poll question information and targeting parameters for a poll campaign. The targeting parameters can describe desired characteristics of the audience of the poll. The poll question information and targeting parameters are stored in the poll storage 304. The publisher module 312 receives 404 poll zone configuration parameters for displaying polls in a poll zone 114 on a publisher webpage 116. A user then visits the publisher webpage 116 and the polling server 102 receives 406 a poll zone content request from a user web browser 118 on a poll user client 110. The polling server 102 may also receive a user identifier 112 from the poll user client 110. The user tracking module 318 determines 408 user information based on the user identifier 112 and the user data storage 314. The user information may include demographic information about the user.

The poll selection module 320 selects 410 a poll for display. If adequate demographic information about the user is known, a poll can be selected from the poll storage 304 by comparing the user demographic information with the targeting parameters of poll campaigns in the poll storage. A poll can also be selected by comparing information about the publisher of the poll zone with the targeting parameters. If some demographic information about the user is not yet known, a demographic poll can be selected for display to obtain further demographic information about the user. The poll presentation module 310 sends 412 information about the selected poll to the poll user client 110. The poll is displayed to the user, the user submits a response to the poll, and the response is received 414 and stored by the poll presentation module 310 in the poll storage results 306 and user data storage 314. The current results received for a particular poll campaign can be provided to a researcher associated with the poll campaign. The results associated with a publisher (across multiple campaigns) can also be provided 416 to the publisher.

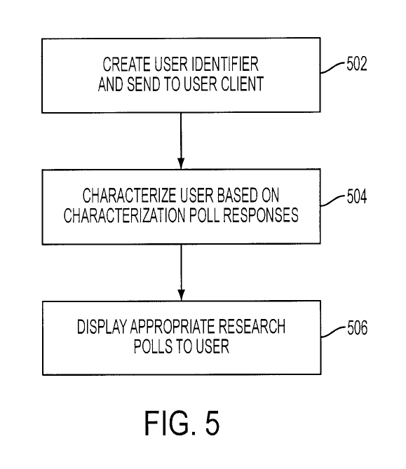

FIG. 5 is a flowchart illustrating an example method for characterizing and polling users. The user tracking module creates 502 a user identifier 112 and sends it to the poll user client 110. This can occur when a poll zone content request is received from an unknown user. The user is then characterized 504 based on the user's responses to characterization polls presented to the user. The user's responses can be tracked with the user identifier 112. The characterization polls presented to the user can include demographic polls, and the user's responses can provide demographic information about the user. When the user has been sufficiently characterized, appropriate research polls can be displayed 506 to the user. As described above, the poll selection module 320 can determine if a user has been sufficiently characterized for presenting a particular research poll to the user based on the targeting parameters of the research poll.

The above description is included to illustrate the operation of certain examples that are not meant to limit the scope of this patent. On the contrary, the scope of this patent extends to all methods and systems fairly falling within the following claims either literally or under the doctrine of equivalents. From the above discussion, many variations will be apparent to one skilled in the relevant art that would yet be encompassed by the spirit and scope of the teachings disclosed herein.

What is claimed is:

1. A method comprising:
counting a number of times a first poll is provided for display to a user with two or more different webpages in two or more different Internet domains; and
if the number of times the first poll has been provided for display to the user exceeds a first threshold number of times, selecting a second poll for display to the user with the two or more different webpages or a third webpage different from the two or more different webpages.

2. The method of claim 1, wherein the first threshold number of times includes one threshold for a first webpage and a second, different threshold for a second webpage.

3. The method of claim 1, further comprising waiting a threshold period of time after displaying the first poll the first threshold number of times before again providing the first poll for display to the user.

4. The method of claim 1, wherein the second poll is associated with a second threshold number of times different than the first threshold number of times based on a relative likelihood of the first poll and the second poll to be taken by the user.

5. The method of claim 1, further comprising:
detecting access to a first webpage by the user; and
selecting the first poll for display to the user when a characteristic of the user satisfies a first targeting parameter defining a first qualifying characteristic for taking the first poll.

6. The method of claim 5, wherein the type of poll comprises at least one of a poll created by the publisher of the first webpage, a poll created by a third party researcher, a poll having a question focused on a particular topic, or a demographic poll.

7. The method of claim 5, wherein the first poll is selected based on a configuration parameter of the first webpage provided by a publisher of the first webpage, the configuration parameter to define at least one of a type of poll to be displayed with the first webpage or a frequency the first poll is to be displayed relative to a frequency that other polls are to be displayed.

8. The method of claim 5, wherein the first characteristic of the user is based on a type of content of the first webpage.

9. The method of claim 5, further comprising:
selecting a third poll for display to the user when the first characteristic of the user does not match the first qualifying characteristic, the third poll comprising a question to illicit an additional characteristic of the user corresponding to the first targeting parameter; and
providing the third poll for display with the first webpage.

10. A system, comprising a processor to at least:
track polls that have been provided for display to a user;
track polls that the user has taken;
count a first number of times a first poll has been provided for display to the user via a first webpage; and
if the first number of times exceeds a first threshold number of times, select a second poll for display to the user via the first webpage or a second webpage, the first and second webpages in different Internet domains.

11. The system of claim 10, wherein the processor is further to:
count a second number of times the first poll is provided for display to the user via the second webpage;
if the first number of times combined with the second number of times exceeds the first threshold number of times, select the second poll for display to the user via the first webpage, the second webpage, or a third webpage different than the first and second webpages.

12. The system of claim 10, wherein the processor is further to adjust the threshold number of times based on a likelihood the user will take the first poll.

13. The system of claim 10, wherein the processor is further to:
detect access to the first webpage by the user;
select the first poll for display to the user via the first webpage when a first characteristic of the user satisfies a first targeting parameter defining a first qualifying characteristic to qualify a user to take the first poll; and
provide the first poll for display via the first webpage.

14. The system of claim 13, wherein the processor is further to:
detect access to the second webpage by the user; and
if the user has not yet taken the first poll, provide the first poll for display via second webpage; and
if the user has already taken the first poll, provide the second poll for display to the user via the second webpage when the first characteristic or a second characteristic of the user satisfies a second targeting parameter defining a second qualifying characteristic to qualify the user to take the second poll.

15. The system of claim 13, wherein the processor is further to:
select a third poll for display to the user when the first characteristic of the user does not match the first qualifying characteristic, the third poll comprising a question to illicit an additional characteristic of the user corresponding to the first targeting parameter; and
provide the third poll for display with the first webpage.

16. A tangible computer readable storage medium comprising instructions that, when executed, cause a machine to at least:
count a number of times a first poll is provided for display to a user via two or more different webpages in two or more different Internet domains; and
if the number of times the first poll has been provided for display to the user exceeds a first threshold number of times, select a second poll for display to the user via the two or more different webpages or a third webpage different from the two or more different webpages.

17. The computer readable storage medium of claim 16, wherein the first threshold number of times includes one threshold for a first webpage and a second, different threshold for a second webpage.

18. The computer readable storage medium of claim 16, wherein the instructions, when executed, further cause the machine to wait a threshold period of time after displaying the first poll the first threshold number of times before again providing the first poll for display to the user.

19. The computer readable storage medium of claim 16, wherein the instructions, when executed, further cause the machine to:
detect access to a first webpage by the user; and
select the first poll for display to the user when a characteristic of the user satisfies a first targeting parameter defining a first qualifying characteristic for taking the first poll.

20. The computer readable storage medium of claim 16, wherein the instructions, when executed, further cause the machine to:
select a third poll for display to the user when the first characteristic of the user does not match the first qualifying characteristic, the third poll comprising a question to illicit an additional characteristic of the user corresponding to the first targeting parameter; and
provide the third poll for display via the first webpage.
